(19) United States
(12) Patent Application Publication
(10) Pub. No.: US 2025/0005450 A1
(43) Pub. Date: Jan. 2, 2025

(54) DYNAMIC ML MODEL SELECTION

(71) Applicant: Telefonaktiebolaget LM Ericsson (publ), Stockholm (SE)

(72) Inventors: Ahmad Ishtar TERRA, Sundbyberg (SE); Rafia INAM, Västerås (SE); Dagnachew Azene TEMESGENE, Johanneshov (SE)

(73) Assignee: Telefonaktiebolaget LM Ericsson (publ), Stockholm (SE)

(21) Appl. No.: 18/688,950

(22) PCT Filed: Sep. 6, 2021
(86) PCT No.: PCT/EP2021/074504

§ 371 Date: Mar. 4, 2024

(51) Int. Cl. G06N 20/00

(52) U.S. Cl. CPC G06N 20/00

(57) ABSTRACT

Methods and apparatus for dynamically selecting an action to be taken in an environment. A method comprises receiving, at a ML agent hosting the plurality of ML models, information about a state of the environment, wherein the information about the state of the environment comprises safety information, and analysing the safety information to determine a risk value for the state of the environment. The method further comprises selecting one of the plurality of ML models, wherein the selection is based on the determined risk value, and processing the information about the state of the environment using the selected ML model to generate a state prediction. The method also comprises generating one or more suggested actions to be performed on the environment using the state prediction.

### TECHNICAL FIELD

Embodiments described herein relate to methods and apparatus for dynamically selecting an action to be taken in an environment using one of a plurality of Machine Learning (ML) models, in particular, for selecting a ML model to generate one or more suggested actions.

### BACKGROUND

Machine Learning (ML) models are used in an increasingly broad range of roles to provide analyses that may otherwise have been accomplished using a human analyst or in another way. There are a wide range of different ML models, having different complexities, accuracies, and so on. Many ML models can perform the same task (such as image processing, speech recognition, Service Level Agreement (SLA) violation prediction, and so on) with different performance and different energy consumptions.

To take into account the inverse proportionality between energy consumption and performance typically exhibited by ML models, it is possible to build two or more models (for example, simpler and more complex models) to do the same task. Where ML models are hosted by a mobile device, or embedded device (for example, within an appliance), Internet of Things (IoT) device, or elsewhere where the power supply is limited, it is possible to switch between more simple and more complex models based on the available processing capabilities or battery levels. “Efficient mapping of crash risk at intersections with connected vehicle data and deep learning models” by Hu, J., Huang, M-C., and Yu, X., Accident Analysis & Prevention Vol. 144, 105665, available at https://www.sciencedirect.com/science/article/abs/pii/S0001457519319062?via%3Dihub as of 16 Aug. 2021 discusses the use of different types of ML models to perform the same task and analyses the performance of various ML models, more specifically, the performance of multi-layer perceptron (MLP) and convolutional neural network (CNN) models are compared to the performance of decision tree models when analysing crash prone intersections.

However, although selection between models based on (for example) available processing resources is possible, typically a ML agent (that is, a device hosting a ML model) will select a ML model based on its capabilities and will then use the selected ML model from then on.

### SUMMARY

It is an object of the present disclosure to provide a method, apparatus and computer readable medium which at least partially address one or more of the challenges discussed above. In particular, it is an object of the present disclosure to provide methods and ML agents that may dynamically select between a plurality of ML models based on a state of an environment to be modelled using the selected ML model.

According to an embodiment there is provided a method for dynamically selecting an action to be taken in an environment using one of a plurality of ML models. The method comprises receiving, at a ML agent hosting the plurality of ML models, information about a state of the environment, wherein the information about the state of the environment comprises safety information. The method further comprises analysing the safety information to determine a risk value for the state of the environment, and selecting one of the plurality of ML models based on the determined risk value. The method further comprises processing the information about the state of the environment using the selected ML model to generate a state prediction; and generating one or more suggested actions to be performed on the environment using the state prediction. By selecting a ML model to be used dynamically based on at least a determined risk value, the method may allow computing resources to be saved and power consumption to be reduced (when a less complex, less resource and power intensive model is selected), while maintaining safety by allowing a more complex model to be selected when required.

In some embodiments, the plurality of ML models may comprise a high complexity ML model and a low complexity ML model, wherein the resource requirements for the high complexity ML model are higher than the resource requirements for the low complexity ML model. Where ML models having differing complexities and resource requirements are available to be selected, the method may allow tailoring of the model selection to the specific circumstances of the environment, in particular based on the risk level.

In some embodiments the method may further comprise, prior to the step of receiving the information about the state of the environment, analysing the resource requirements of each of the plurality of ML models, and storing the results of the analysis for use in the step of selecting of one of the plurality of ML models. In this way, the method obtains resource requirement information that may be taken into account in the selection of a ML model, allowing the method to select the most appropriate model in terms of resource efficiency and performance based on a particular state of the environment.

In some embodiments, the selection of one of the plurality of ML models may be based on a comparison of the determined risk value with one or more predetermined safety thresholds, or using a plurality of selection rules, or using a model selection ML model. These different approaches to selecting a ML model from among the plurality of ML models are suitable for different implementations of embodiments, covering a range of system configurations and complexities.

In some embodiments, the method may further comprise performing feature adaptation on the state prediction, prior to the step of generating one or more suggested actions, wherein the feature adaptation ensures that the state prediction is in a suitable format for use in the suggested action generation. In this way, the results from different ML models (potentially of different complexities) having different output formats may all be made compatible with further system components, improving the practical usability of the state predictions.

According to a further embodiment there is provided a ML agent configured to dynamically select an action to be taken in an environment using one of a plurality of ML models, the ML agent comprising processing circuitry and a memory containing instructions executable by the processing circuitry. The ML agent is operable to receive information about a state of the environment, wherein the information about the state of the environment comprises safety information. The ML agent is further operable to analyse the safety information to determine a risk value for the state of the environment, and select one of the plurality of ML models, wherein the selection is based on the determined risk value. The ML agent is further operable to process the information about the state of the environment using the selected ML model to generate a state prediction, and to generate one or more suggested actions to be performed on the environment using the state prediction. The ML agent may provide some or all of the advantages discussed above in the context of the methods.

Further embodiments provide systems and computer-readable media comprising instructions for performing methods as set out herein.

Certain embodiments may provide an advantage of allowing the most appropriate ML model to be used; as the selection is dynamic (based on information about the state of the environment when the selection is made), embodiments may adapt based on changes in the environment. The use of less complex/less resource intensive ML models for some states of the environment (such as low risk states) allows rapid results to be obtained with reduced resource consumption. Further, as higher complexity/more resource intensive ML models may be used for some states of the environment (such as high-risk states), safety compromises may be avoided. Embodiments therefore allow increased time efficiency and resource efficiency, while maintaining safety.

### BRIEF DESCRIPTION OF DRAWINGS

The present disclosure is described, by way of example only, with reference to the following figures, in which:—

FIG. 1 is a flowchart of a method in accordance with embodiments;

FIGS. 2A and 2B are schematic diagrams of ML agents in accordance with embodiments;

FIG. 3 is a scheduling diagram showing a process for determining ML model energy consumption in accordance with an embodiment;

FIGS. 4A and 4B are a scheduling diagram of a ML model selection in accordance with an embodiment;

FIG. 5 is a plot showing a variation in latency for a communications network environment in accordance with an embodiment; and

FIGS. 6A and 6B are images showing implementations of image segmentation in accordance with an embodiment.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

As discussed above, existing ML agents will typically make a selection between available ML models based on the capabilities of the device that will host the model, and then continue to use the selected model without making further selections. Embodiments of the present invention aim to provide increased versatility by allowing dynamic selection of ML models. In particular, a selection between a plurality of ML models that may be used to model an environment may be made based on information about a state of the environment, said information comprising safety information. Accordingly, embodiment may allow ML models with lower resource requirements to be used when use of these models will not cause safety issues. Some advantages provided by embodiments are discussed in greater detail elsewhere in the application.

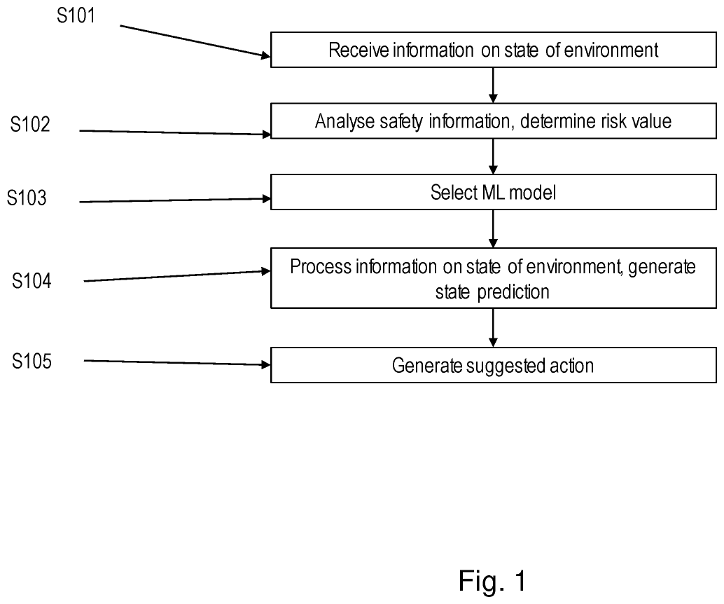

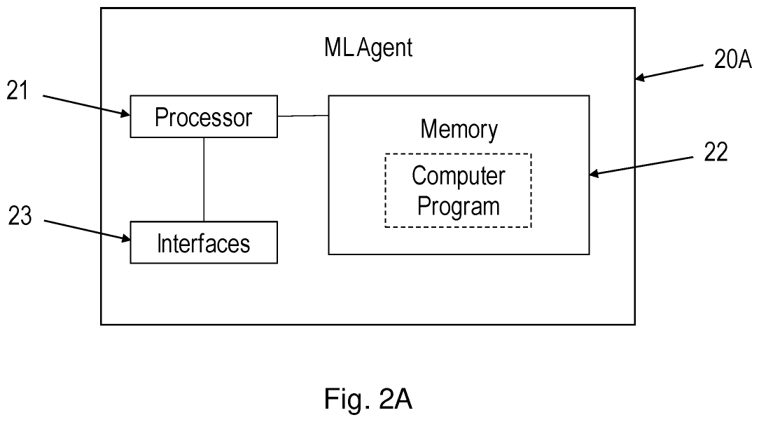

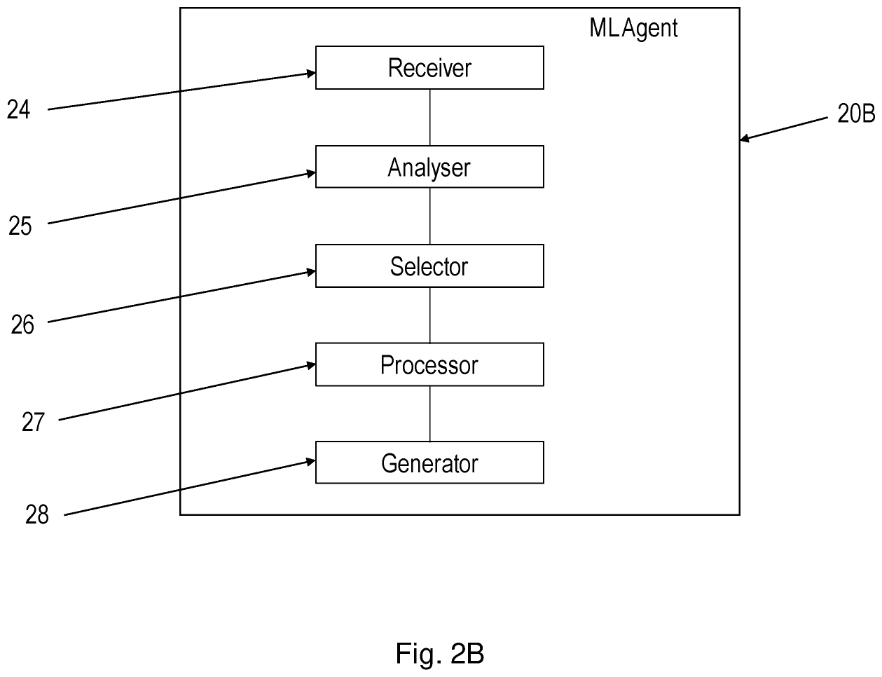

A method in accordance with embodiments is illustrated in the flowchart of FIG. 1. The method allows the dynamic selection of an action to be taken in an environment, the action being provided by one of a plurality of ML models. The method may be executed by any suitable apparatus. Examples of ML agents 20A, 20B in accordance with embodiments that are suitable for executing the method are shown schematically in FIG. 2A and FIG. 2B. One or more of the ML agents 20A, 20B shown in FIGS. 2A and 2B may be incorporated into a system, for example, where the system is all or part of a telecommunications network, one or more of the ML agents 20A, 20B used to execute the method may be incorporated into a base station, core network node, user equipment (UE) or other network component.

As shown in step S101 of FIG. 1, the method comprises receiving at a ML agent hosting the plurality of ML models, information about a state of the environment, wherein the information about the state of the environment comprises safety information. The exact nature of the safety information is dependant on the environment which the ML agent may be used to provide suggested actions in relation to. As will be appreciated, embodiments may be utilised in a wide variety of different environments; examples of environments in which embodiments may be utilised include communications networks (or parts thereof), Human Robot Collaboration (HRC) areas, autonomous agent operation areas (for example, areas in which Unmanned Autonomous Vehicles, UAVs, operate), and so on. Where the environment is all or part of a communications network (such as a 3^{rd} Generation Partnership Project, 3GPP, 4^{th} Generation, 4G, or 5th Generation, 5G, communication network), the safety information may comprise, for example, information from base stations, UEs, core network nodes, and so on that may be used to calculate the risk of a Service Level Agreement (SLA) being violated due to one or more Key Performance Indicators (KPI) straying outside the bounds specified in the SLA. Where the environment is a HRC area, the safety information may comprise, for example, information from robots or robot controllers that may be used to calculate the risk of a collision between a robot and a human or other obstacle (such as another robot, other equipment, building structure, and so on). Where the environment is an autonomous agent operation area, the safety information may comprise, for example, information from UAVs or UAV controllers that may be used to calculate the risk of a collision between a UAV and an obstacle (another UAV, a building, a geographical feature, a restricted area, and so on). Typically, the safety information is sensory information that may be analysed to derive a risk value for the state of the environment (see step S102); this sensory information may be received directly from sensors and/or via an intermediary apparatus that collates sensor readings and transmits the sensor readings to the ML agent. In some embodiments, the ML agent may be or form part of an apparatus; where this is the case the apparatus may also include one or more sensors. Where a ML agent 20A in accordance with the embodiment shown in FIG. 2A is used, the information about the state of the environment may be received in accordance with a computer program stored in a memory 22, executed by a processor 21 in conjunction with one or more interfaces 23. Alternatively, where a ML agent 20B in accordance with the aspect of an embodiment shown in FIG. 2B is used, the information about the state of the environment may be received by the receiver 24.

Once the safety information has been received, the method further comprises analysing the safety information to determine a risk value for the state of the environment as shown in step S102. The risk value indicates the relative risk of a safety violation occurring. As will be appreciated by those skilled in the art, what constitutes a safety violation is dependent on the nature of the environment. Using the example environments discussed above; where the environment is a communications network, a safety violation may be a SLA being violated (for example, a latency value exceeding that specified in a SLA, a data throughput falling below a value specified in a SLA, and so on). Where the environment is a HRC area or autonomous agent operation area, a safety violation may be a robot or UAV respectively colliding with or coming within a predetermined distance of an obstacle. The risk value may represent the relative risk of safety violation in any suitable form; as an example of this, a numerical scale (from 0 to 10, for example) may be used whereby low values indicate a lower risk of a safety violation occurring and higher values indicate a higher risk of safety violation. Alternative examples include but are not limited to a colour spectrum with (for example) blue indicating a lower risk of safety violation and red a higher risk, or the risk values categorised as low, medium and high. The derivation of the risk value may utilise a ML model trained to analyse obtained safety information and derive a risk value, wherein the ML model may be a neural network, a decision tree, and so on. In some embodiments, a safety analysis module may be used to analyse the safety information and derive risk values; the safety analysis module is typically a software module forming part of a ML agent. Where a ML agent 20A in accordance with the embodiment shown in FIG. 2A is used, the risk value may be determined in accordance with a computer program stored in a memory 22, executed by a processor 21 in conjunction with one or more interfaces 23. Alternatively, where a ML agent 20B in accordance with the aspect of an embodiment shown in FIG. 2B is used, the risk value may be determined by the analyser 25.

The risk value determined for the state of the environment, based on the safety information, is then used to dynamically select one of a plurality of ML models available to the ML agent, as shown in step S103. The selection of one of the plurality of ML models is dynamic in that it is determined based on the current information (state of the environment, safety information, and so on) at the time of selection, rather than the selection being predetermined. The ML models available to the ML agent have all been trained (using any suitable training mechanism, such as supervised learning, reinforcement learning, unsupervised learning and so on) to execute a task. In some embodiments, all of the plurality of ML models are trained to perform the same task. Alternatively, ML models from among the plurality of ML models available to the ML agent may be trained to perform different tasks. Where ML models from among the plurality of ML models are trained to perform different tasks, typically these tasks are related, for example, are intended to achieve the same or similar objectives. An example of related tasks may be as follows; where the environment is a communications network as discussed above and a SLA agreement relating to maximum acceptable latencies being violated constitutes a safety violation, a ML model from among the plurality of ML models may be trained to provide a binary prediction of whether or not a safety violation will occur within a predetermined time period (for example, 30 minutes). A further ML model from among the plurality of ML models may be trained to perform the related, more complex task of predicting when a safety violation may occur, and potentially also to predict the duration of a safety violation (in this example, the duration of time for which the latency may be above an agreed maximum threshold). The ML model is therefore trained to provide a binary classification, while the further ML model is trained to provide a prediction using, for example, regression analysis. Although the ML model and further ML model in the above example are not trained to perform the same task, the general objective of the ML models, predicting high latency, is the same.

In some embodiments, the plurality of ML models may comprise models of differing complexity typically with correspondingly different resource requirements. The less complex ML models typically have fewer parameters than the more complex ML models, therefore processing a state of the environment using a less complex ML model typically requires fewer resources than processing the same state of the environment using a more complex ML model. The term “resources” is used to refer to computing resources such as processor and memory resources, transmission resources, and so on. The plurality of ML models may comprise a high complexity ML model and a low complexity ML model, wherein the resource requirements for the high complexity ML model are higher than the resource requirements for the low complexity ML model. The plurality of ML models may further comprise one or more further ML models having complexities and resource requirements between those of the high and low complexity ML models. That is, the plurality of ML models may further comprise a medium complexity ML model wherein the resource requirements for the medium complexity ML model are higher than the resource requirements for the low complexity ML model and lower than the resource requirements for the high complexity ML model. The plurality of ML models that may be selected by the ML agent may comprise 4, 5, 6 or more ML models, all having varying relative levels of complexity and/or varying resource requirements. The different complexity ML models may be versions of the same ML model, for example, the less complex ML models may be compressed versions of the more complex ML models. The different complexity ML models may also be different ML models (rather than more or less complex versions of the same ML model). Where the plurality of ML models comprises a larger number of ML models, for example, 9 ML models, the plurality of ML models may comprise a mixture of different compression level versions of a number of different ML models (continuing with an example wherein the plurality of ML models comprises 9 ML models, these 9 ML models may be 3 different compression levels of each of 3 different ML models).

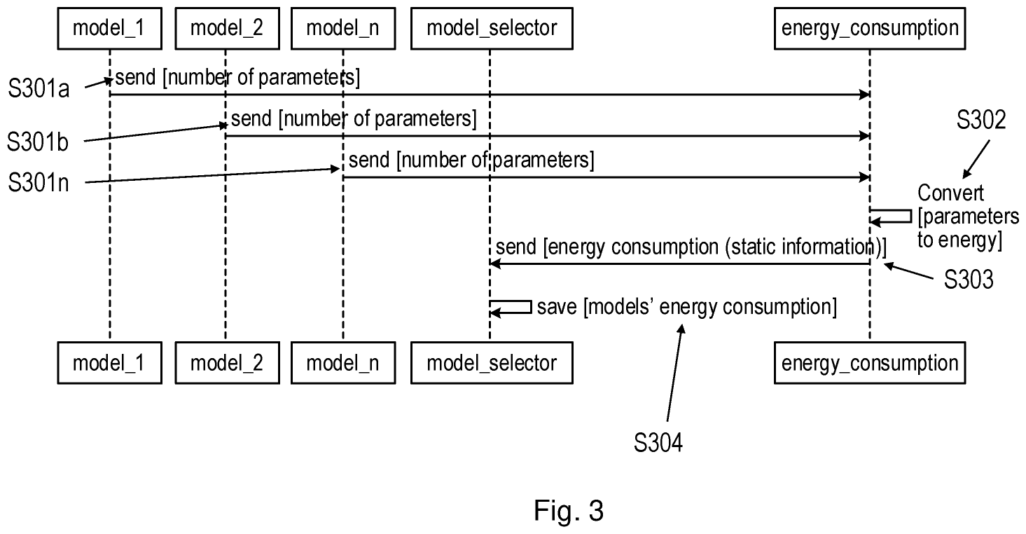

In some embodiments, prior to the step of selecting a ML model and potentially prior to the step of receiving the information about the state of the environment (including the safety information), the method may further comprise analysing the resource requirements of one or more of the plurality of ML models, preferably of each of the plurality of ML models. The analysis of the resource requirements may be performed by the ML agent itself. Alternatively, where trained ML models are provided to the ML agent, the ML models may be provided with additional information indicating the resource requirements of the models. FIG. 3 is a sequence diagram showing an example method for determining the resource requirements (specifically, energy consumption) of plural ML models in accordance with embodiments. As shown in steps S301a, S301b and S301n, each of a plurality of ML models model_1, model_2 and model_n sends to an energy consumption calculation module the number of parameters used by the ML model. The energy consumption module may form part of a ML agent 20, or may be a separate component. The example shown in FIG. 3 includes 3 ML models; as discussed above the total number of ML models in the plurality of ML models may be greater or smaller than this number. In the example shown in FIG. 3, model_1 is the most complex ML model among the plurality of ML models, model_n is the least complex ML model, and model_2 has a complexity between model_1 and model_n. Having received the number of parameters information from each of the plurality of ML models, the energy consumption calculation module then converts this information into an estimated energy consumption for each of the ML models, as shown in step S302. The estimated energy consumptions are then transmitted to a model selector module in step S303, and saved by the model selector (in step S304). The energy consumption information may then be used as resource requirement information in the selection of a ML model, as discussed below.

The selection of a ML model from among the plurality of ML models is based on the determined risk value. As the risk value is indicative of the state of the environment, and in particular of the risk of a safety violation in the environment, the ML model selection is therefore based on the state of the environment. Taking the state of the environment into consideration when selecting which ML model to use allows the ML agent to potentially save resources by selecting a ML model having lower complexity (and typically lower resource requirements) when the risk of safety violation is lower, while still retaining the ability to select a ML model having higher complexity (and typically higher resource requirements) when the risk value indicates a higher risk of safety violation. In some embodiments, the selection is based on the risk value alone. Where the selection is made based only on the risk value, when the risk value is below a predetermined safety threshold (that is, the risk of safety violation is low) a low complexity ML model may be selected, and above the threshold a more complex ML model may be selected. Where there are a larger number of ML models among the plurality of ML models, a corresponding number of thresholds may be used; for example, where there are 8 ML models of differing complexity among the plurality of ML models, the ML models may be arranged in order of complexity with 7 corresponding thresholds used to select between the models.

In some embodiments, in addition to the risk value, the selection of one of the plurality of ML models may also be based on other factors such as a power status of an apparatus hosting the ML agent. Taking the power status of the apparatus into consideration may be of particular use where the apparatus has limited power reserves available, for example, where the apparatus is a wireless device or IoT device operating using battery power without a constant mains power source connection. Other factors that may be taken into account include, for example, the total processing resources available to the ML agent. Taking the total processing resources into consideration may be of particular relevance where the processing resources are also to be utilised to perform other tasks; even where the ML agent may be able to obtain sufficient processing resources to execute a complex ML model, it may be desirable to avoid this if executing the complex ML model will use a large portion of the total processing resources of an apparatus of which the ML agent is part thereby hampering the performance of other tasks.

In aspects of embodiments wherein the selection of the ML model is based on additional factors as well as the risk value, the selection may utilise a plurality of selection rules. Where selection rules are utilised, the rules may be defined by a human operator and applied by the ML agent in the selection of the ML model. The rules may take any suitable form, for example a number of logical statements. The rules may apply differing levels of importance to different factors when considering the ML model selection; typically, the risk value is weighted more heavily (of higher importance) than other factors. As an alternative to the use of selection rules, the selection of a ML model from among the plurality of ML models may utilise a model selection ML model. A model selection ML model is a further ML model (separate from the plurality of ML models) that has been trained to select a ML model from among the plurality of ML models based on the risk value and other factors. Typically, a model selection ML model may be utilised when a large number of other factors (of differing weightings) are to be taken into consideration and therefore defining a suitable set of selection rules would be complex and arduous.

Where a ML agent 20A in accordance with the embodiment shown in FIG. 2A is used, the selection of a ML model from among the plurality of ML models using the risk value may be made in accordance with a computer program stored in a memory 22, executed by a processor 21 in conjunction with one or more interfaces 23. Alternatively, where a ML agent 20B in accordance with the aspect of an embodiment shown in FIG. 2B is used, the selection of a ML model from among the plurality of ML models using the risk value may be made by the selector 26.

When a ML model from among the plurality of ML models has been selected, the selected ML model is then used to process the information about the state of the environment, thereby generating a state prediction (as shown in step S104 of FIG. 1). The state prediction is a prediction of the state of the environment at some point in time after that represented by the processed information about the state of the environment.

As explained above, different ML models among the plurality of ML models may perform different tasks. It is not necessarily true that the different ML models among the plurality of ML models perform different tasks; in some embodiments the different ML models perform the same task (with more complex ML models among the plurality of ML models potentially producing more accurate results than less complex models among the plurality of ML models). Where the different ML models perform different tasks, the state predictions generated by the ML models may take different forms from one another. Returning to the example discussed above (with reference to step S103) in which the environment is a communications network and a SLA agreement relating to maximum acceptable latencies being violated constitutes a safety violation. A simple ML model from among the plurality of ML models may be trained to provide a binary prediction of whether or not a safety violation will occur within a predetermined time period (for example, 30 minutes). A complex ML model from among the plurality of ML models may be trained to perform the related, more complex task of predicting when a safety violation may occur, and potentially also to predict the duration of any predicted safety violation (in this example, the duration of time for which the latency may be above an agreed maximum threshold). Accordingly, a state prediction from the simple ML model may be (for example) “safety violation occurs within 30 min=YES”, wherein the possible predictions from the simple ML model are YES or NO (that is, the 30 minute duration is fixed). A state prediction from the complex ML model may be (for example) “safety violation occurs in 17 min, duration 5 min”, wherein the possible predictions include indicating whether or not a safety violation is predicted to occur and, if a safety violation is predicted to occur, the predicted time until the violation and duration of the violation (that is, the 17 min value and 5 min value in the example prediction may both vary). The state prediction from the complex model may therefore be in a different format to that from the simple model, in particular containing more detailed information than that from the simplex ML model.

The state prediction generated by a ML model from among the plurality of ML models may be subsequently used to generate one or more suggested actions to be performed on the environment; a component used to generate the suggested action (such as a ML agent executing a ML model trained for this purpose, a rule based selection algorithm, or another component in the environment, for example) may be configured to accept state predictions in a particular format. Where different ML models from among the plurality of ML models generate state predictions in different formats, the method may further comprise performing feature adaptation on the state prediction, prior to the use of the state prediction in the generation of one or more suggested actions, wherein the feature adaptation ensures that the state prediction is in a suitable format for use in the suggested action generation. The feature adaptation may comprise reducing the amount of detail provided by more complex models, although typically this is not the case and the state predictions produced by more simple models (having less detailed information) are modified to match the format of the state information produced by the more complex models. Returning to the example discussed above in which a state prediction from the simple ML model may be (for example) “safety violation occurs within 30 min=YES” and a state prediction from the complex ML model may be (for example) “safety violation occurs in 17 min, duration 5 min”, feature adaptation may be performed on the state prediction from the more simple model. The exact nature of the feature adaptation is dependent upon the state prediction used by subsequent components; in the example, the simple ML model state prediction of “safety violation occurs within 30 min=YES” may be converted to “safety violation occurs in 15 min, duration 10 min”, where 15 min is selected as the midpoint of the interval the simple ML model predicts state violation to occur within and 10 min is a general average duration of safety violations for the system in question (not related to the specific state prediction from the simple ML model).

Where a ML agent 20A in accordance with the embodiment shown in FIG. 2A is used, the processing of the state of the environment to generate the state prediction (and potentially also feature adaptation where this is used) may be performed in accordance with a computer program stored in a memory 22, executed by a processor 21 in conjunction with one or more interfaces 23. Alternatively, where a ML agent 20B in accordance with the aspect of an embodiment shown in FIG. 2B is used, the processing of the state of the environment to generate the state prediction (and potentially also feature adaptation where this is used) may be performed by the processor 27.

The state prediction (which may have been modified following feature adaptation) may then subsequently be used to generate one or more suggested actions to be performed on the environment, as shown in step S105 of FIG. 1. The suggested actions vary depending on the environment; where the environment is all or part of a communications network, the suggested actions may comprise activating or deactivating all or part of a base station, rerouting traffic, and so on. Where the environment is a HRC area, the suggested actions may comprise halting or rerouting robot movements, and so on. Where the environment is an autonomous agent operation area, the suggested actions may comprise prohibiting entry to UAVs not already in the area, rerouting UAVs already in the area, defining priority zones, and so on. Where a ML agent 20A in accordance with the embodiment shown in FIG. 2A is used, the generation of the suggested actions using the state prediction may be performed in accordance with a computer program stored in a memory 22, executed by a processor 21 in conjunction with one or more interfaces 23. Alternatively, where a ML agent 20B in accordance with the aspect of an embodiment shown in FIG. 2B is used, the generation of the suggested actions using the state prediction may be performed by the generator 28.

Some embodiments may further comprise selecting an action from the one or more suggested actions, and modifying the environment based on the selected action. The modifications to the environment may be enacted directly by an apparatus (for example, ML agent 20) performing a method in accordance with embodiments, or an apparatus (for example, ML agent 20) may send instructions to further components such as base stations, robot controllers and so on, wherein the instructions cause the further components to execute the selected action.

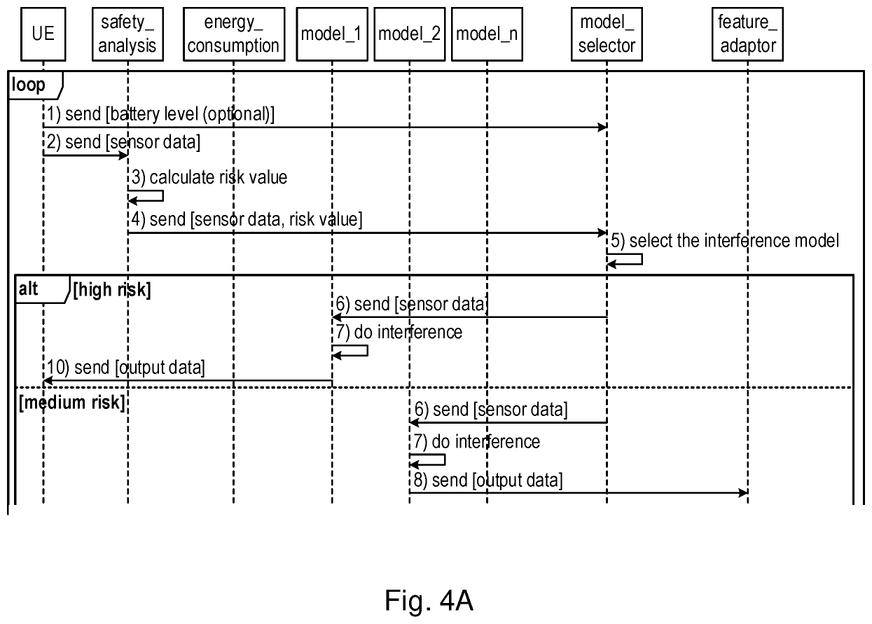

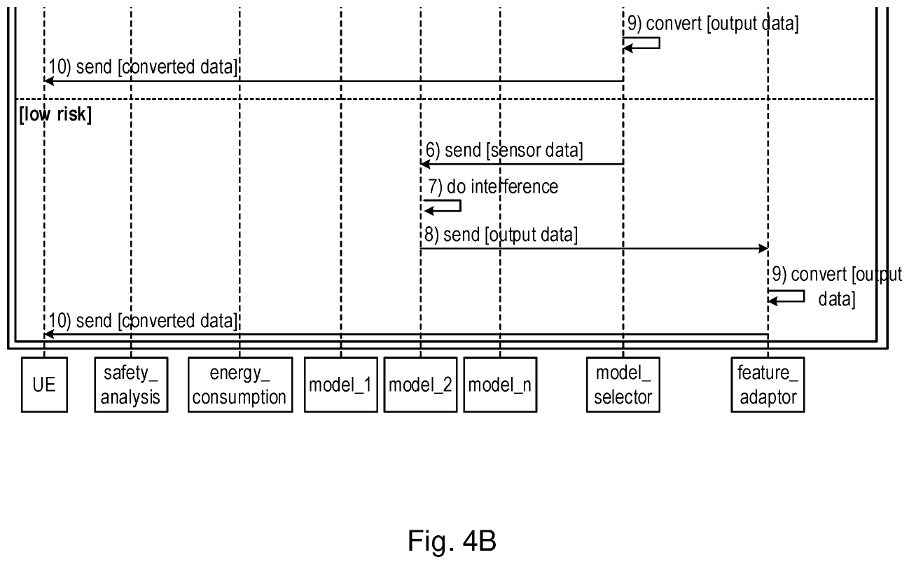

FIG. 4A and FIG. 4B (collectively FIG. 4) are a sequence diagram illustrating how an example of an embodiment may be implemented where the environment is all or part of a communications network. More specifically, the example shown in FIG. 4 is used in a 3GPP 5G communications network. Typically, 3GPP 5G networks support network slices; this is the case for the communication network to which FIG. 4 relates. In the example illustrated in FIG. 4, the risk value indicates the risk of a SLA agreement relating to the latency (a KPI) experienced by a network slice being violated. The example shown in FIG. 4 builds upon that shown in FIG. 3; as discussed above in the context of FIG. 3, the energy consumption of each of ML models model_1, model_2 and model_n has been calculated, sent to the model selector module and stored.

In the example shown in FIG. 4, a ML agent that performs the method forms part of a User Equipment (UE). The UE uses battery power, rather than a mains power connection. Accordingly, in step 1 of the example shown in FIG. 4, the battery power level of the UE is sent to the model selector for subsequent use in selecting a ML model from among the plurality of ML models; the step of obtaining the UE battery level does not necessarily take place before ML model selection. In step 2 of FIG. 4, the UE sends information about a state of the environment, obtained from sensor data and including safety information, to an analyser of the ML agent. The analyser performs a safety analysis to determine a risk value for the state of the environment (see step 3), and then passes the determined risk value to a selector for use in the selection of a ML model from among the plurality of ML models (see step 4). In this example, the information about the state of the environment, including the sensor data, is also passed to a selector. The selector performs model selection based on the risk value, the UE battery level and the energy consumption of the models (obtained as shown in FIG. 3), and selects one of the plurality of ML models as shown in step 5.

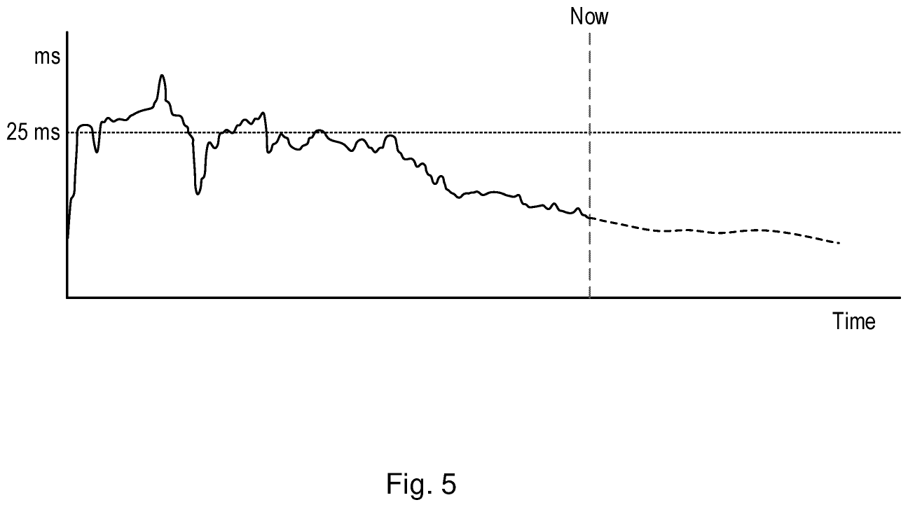

FIG. 4 shows three different alternative options which may be selected depending upon which of model_1, model_2 and model_n is selected. In the example shown in FIG. 4, model_1 is selected in a high risk scenario, model_2 is selected in a medium risk scenario and model_n is selected in a low risk scenario. Where model_1, the most complex and resource intensive of the three models, is selected, the information about the state of the environment is sent to this ML model (see step 6), which then processes the information about the state of the environment to generate a state prediction. In the example shown in FIG. 4, the state prediction used to generate suggested actions comprises an inferred variation in the latency over a predetermined time period. FIG. 5 is a plot showing the variation in latency over time; the plot also shows the latency level constituting a safety violation (the level at which the SLA is breached); 25 ms. The solid line on FIG. 5 indicates measured latencies. The latencies after the current measurement time (indicated as “Now” on FIG. 5) are predictions and are indicated by a dashed line on FIG. 5. The most complex of the ML models, model_1, generates a state prediction in the format required to generate suggested actions, so the state prediction output data can be sent to a further component in the UE (see step 10) to be used in the generation of one or more suggested actions. By contrast, neither the mid complexity ML model (model_2) nor low complexity ML model (model_n) generate state predictions in the format required to generate suggested actions. Accordingly, as shown in FIG. 4, the state predictions output by model_2 and model_n are sent to a feature adaptor (step 8) where the state predictions are converted (step 9) into the format used in the generation of one or more suggested actions. The converted state predictions from model_2 and model_n are then sent to a further component in the UE (see step 10) to be used in the generation of one or more suggested actions.

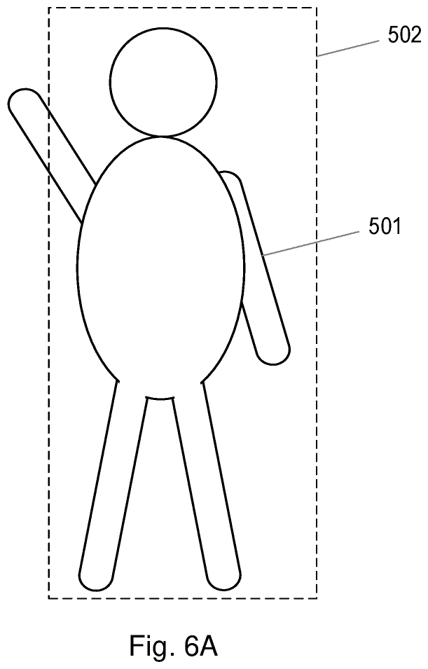

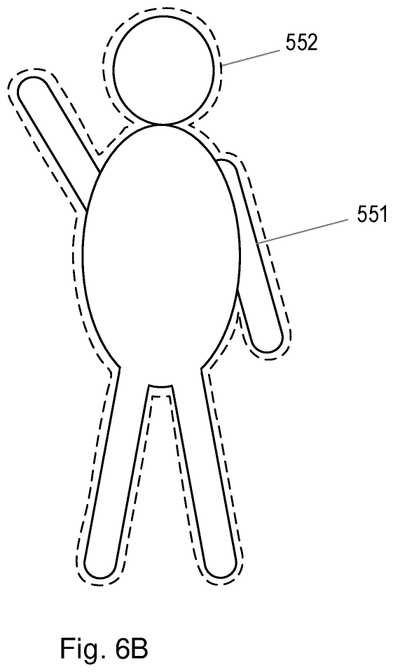

FIG. 6A and FIG. 6B are simplified versions of images captured by robots, showing two different implementations of image segmentation. In HRC environments, it is important for robots and/or robot controllers to identify any obstacles located around robots. One method that has been developed is using image processing, specifically image segmentation. In image segmentation, obstacles are identified in captured images (the object may be said to occupy a segment of the image) using a suitable ML model such as a trained deep neural network model (DNN) to determine what action need to be taken by the robot in order to maintain the safety of the operation. A safety violation may be said to occur if a robot collides with another object (such as humans, other robots, or any other object).

Image segmentation is a well-researched area, accordingly, a wide variety of ML models are available. Two examples of models that may be used for image segmentation are Multi-level Scene Description Networks (MSDN) and Mask-Recursive Convolutional Neural Networks (Mask-RCNN). MSDN models have a lower complexity than Mask-RCNN models, and also a lower performance. The output of a MSDN model is a list of rectangular bounding boxes that identify the approximate rectangular position of the obstacle in the image (also referred to as a region of interest, ROI). Mask-RCNN models generate more precise segmentation masks identifying the position of the obstacle in the image with pixel accuracy. FIG. 6A shows a simplified version of an image processed using a MSDN. In FIG. 6A the object is a human (501); as can be seen in FIG. 6A the rectangular bounding box (502) generated by the MSDN indicates the approximate position of the human in the image. FIG. 6B shows the same simplified image as FIG. 6A, in FIG. 6B the simplified image has been processed using a Mask-RCNN. In FIG. 6B the portion of the image occupied by the human (551) (that is, the ROI) is identified to a higher precision than that shown in FIG. 6A, as indicated by the mask outline (552).

In some situations, the finer details of the object detection may be important as avoiding collisions involves measuring the distance from a robot to the identified obstacle(s). The visual camera used to capture the images shown in simplified form in FIG. 5 may be coupled with a depth-sensing infra-red (IR) camera. The identified ROI may then be combined with the IR camera data to measure the distance to the obstacle (human). As the MSDN model only generates bounding boxes, the average value of the pixels within the bounding box 502 may result in a distance measurement including an error because pixels that are not showing the human would also be considered. In FIG. 6A, the pixels not showing the human would show the background (for example, a wall of a room), and would therefore be further from the robot than the human (501). The distance measurement would therefore err towards a value larger than the actual distance to the human. Thus, it would be more dangerous for the robot using MSDN to identify the distance to an obstacle. However, the MSDN model is more resource efficient, and is able to act as an object detection model providing a binary measurement of whether an obstacle is present or not. Accordingly, in the present example, the less complex model (for example, MSDN model) may be selected when the risk value is low to provide a binary classifier, determining whether or not an obstacle is present. If the risk value is higher, for example, the safety information indicates that an obstacle is likely to be present, the more complex model (for example, Mask-RCNN model) may be used so the object identification is accurate and distance measurement is more precise, resulting in safer operations. In the present example, detailed analysis of images where there is no obstacle may be avoided, and energy consumption reduced in safe situations.

Continuing with the example shown in FIG. 6A and FIG. 6B, the output of the more complex model (for example, Mask-RCNN model) may be accurate distance and position measurements for any objects present. By contrast, the output from the less complex model (for example, MSDN model) may not provide this information. If the MSDN model indicates that an object is present, the model may also indicate an approximate position of the object relative to the robot (that is, an approximate direction and distance to the object). As explained above, the nature of the MSDN output precludes accurate distance measurement, feature adaptation may be performed such that the estimated distance to the object is output as the closest measured distance from the distances measured for the pixels in the MSDN ROI. This would then give a worst case scenario type output (that is, smallest possible separation to the object), minimising the risk of a collision between the robot and object.

By allowing the selection of a ML model from among a plurality of ML models, embodiments may allow the most appropriate ML model to be used; as the selection is dynamic (based on information about the state of the environment when the selection is made) embodiments may adapt based on changes in the environment. The use of less complex/less resource intensive ML models for some states of the environment (such as low risk states) allows rapid results to be obtained with reduced resource consumption. Further, as higher complexity/more resource intensive ML models may be used for some states of the environment (such as high risk states), safety compromises may be avoided. Embodiments therefore allow increased time efficiency and resource efficiency, while maintaining safety.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for dynamically selecting an action to be taken in an environment using one of a plurality of Machine Learning, ML, models, the method comprising:
receiving, at a ML agent hosting the plurality of ML models, information about a state of the environment, wherein the information about the state of the environment comprises safety information;
analyzing the safety information to determine a risk value for the state of the environment;
selecting one of the plurality of ML models, wherein the selection is based on the determined risk value;
processing the information about the state of the environment using the selected ML model to generate a state prediction; and
generating one or more suggested actions to be performed on the environment using the state prediction.

2. The method of claim 1, wherein the plurality of ML models has been trained to perform the same task.

3. The method of claim 1, wherein the plurality of ML models comprises a high complexity ML model and a low complexity ML model, and wherein the resource requirements for the high complexity ML model are higher than the resource requirements for the low complexity ML model.

4. The method of claim 3, wherein the plurality of ML models further comprises a medium complexity ML model, and wherein the resource requirements for the medium complexity ML model are higher than the resource requirements for the low complexity ML model and lower than the resource requirements for the high complexity ML model.

5. The method of claim 3 further comprising, prior to the step of receiving the information about the state of the environment, analyzing the resource requirements of each of the plurality of ML models, and storing the results of the analysis for use in the step of selecting of one of the plurality of ML models.

6. The method of claim 1, wherein the selection of one of the plurality of ML models is based on a comparison of the determined risk value with one or more predetermined safety thresholds.

7. The method of claim 1, wherein the ML agent is or forms part of an apparatus, and wherein the selection of one of the plurality of ML models is further based on a power status of the apparatus.

8. The method of claim 7, wherein the selection of one of the plurality of ML models utilizes a plurality of selection rules.

9. The method of claim 7, wherein the selection of one of the plurality of ML models utilizes a model selection ML model.

10. The method of claim 1 further comprising performing feature adaptation on the state prediction, prior to the step of generating one or more suggested actions, wherein the feature adaptation ensures that the state prediction is in a suitable format for use in the suggested action generation.

11. The method of claim 1, further comprising selecting an action from the one or more suggested actions, and modifying the environment based on the selected action.

12. The method of claim 1, wherein the environment is at least a portion of a communications network.

13. The method of claim 12, wherein the method is performed by a node in the communications network, wherein the node is:
a User Equipment, UE;
an Internet of Things, IoT, device;
a next generation base station, gNB; or
a Core Network Node.

14. The method of claim 1, wherein the environment is a Human Robot Collaboration, HRC, area.

15. The method of claim 14, wherein the method is performed by a robot or robot controller in the HRC area.

16. The method of claim 1, wherein the environment is an autonomous agent operation area.

17. The method of claim 16, wherein the method is performed by an Unmanned Autonomous Vehicle, UAV.

18. A Machine Learning, ML, agent configured to dynamically select an action to be taken in an environment using one of a plurality of ML models, the ML agent comprising processing circuitry and a memory containing instructions executable by the processing circuitry, whereby the ML agent is operable to:
receive information about a state of the environment, wherein the information about the state of the environment comprises safety information;
analyze the safety information to determine a risk value for the state of the environment;
select one of the plurality of ML models, wherein the selection is based on the determined risk value;
process the information about the state of the environment using the selected ML model to generate a state prediction; and
generate one or more suggested actions to be performed on the environment using the state prediction.

19.-34. (canceled)

35. A Machine Learning, ML, agent configured to dynamically select an action to be taken in an environment using one of a plurality of ML models, the ML agent comprising:
a receiver configured to receive information about a state of the environment, wherein the information about the state of the environment comprises safety information;
an analyzer configured to analyze the safety information to determine a risk value for the state of the environment;
a selector configured to select one of the plurality of ML models, wherein the selection is based on the determined risk value;
a processor configured to process the information about the state of the environment using the selected ML model to generate a state prediction; and
a generator configured to generate one or more suggested actions to be performed on the environment using the state prediction.

36. A computer program product comprising a non-transitory computer-readable medium comprising instructions which, when executed on processing circuitry, cause the processing circuitry to perform a method in accordance with claim 1.
